(19) United States
(12) Patent Application Publication
(10) Pub. No.: US 2004/0089156 A1
(43) Pub. Date: May 13, 2004

(54) Dynamic electrostatic aerosol collection apparatus for collecting and sampling airborne particulate matter

(76) Inventors: Vladimir Gartstein, Cincinnati, OH (US); Alan David Willey, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/697,229

(22) Filed: Oct. 30, 2003

Related U.S. Application Data
(60) Provisional application No. 60/422,345, filed on Oct. 30, 2002.

(51) Int. Cl. B03C 3/00

(52) U.S. Cl. 96/53

(57) ABSTRACT

A dynamic electrostatic aerosol filter and collection system is provided that collects airborne particulate matter, including biological materials. Once collected, the particles can be directed to sensing stations for real-time detection of dangerous materials, and this can be achieved in a continuous re-circulation system. As an option, the collection fluid can be diverted to a station where a detailed analysis is performed, in a batch operation. The filter/collection system is also useable as a concentration “concentrator” to more quickly detect dangerous materials, such as smallpox germs.

### CROSS REFERENCE TO RELATED APPLICATION

This application claims the benefit of U.S. Provisional Application No. 60/422,345, filed Oct. 30, 2002.

### TECHNICAL FIELD

The present invention relates generally to aerosol collection equipment and is particularly directed to an aerosol collecting device of the type which sprays electrically charged liquid droplets into an air stream to aid in collection of particulate matter. The invention is specifically disclosed as an aerosol collecting device that charges semiconductive liquid droplets and sprays them into a chamber through which an air flow passes that initially contains entrained particles or biological organisms. The liquid droplets are charged, and the particles/organisms are attracted to the droplets, which are accumulated on a collecting surface. The collected liquid is then sampled for analysis, and also recirculated and again used to collect further particles/organisms.

### BACKGROUND OF THE INVENTION

Indoor air includes many small particles which can, more likely than ever before, include dangerous chemicals or biological organisms. Conventional filtration systems have been used to reduce the amount of small particles in selected locations, however such conventional filtration systems are either very inefficient at collecting very small particles, or a large amount of energy is required for such filtration systems to be able to capture such small particles.

Even filtration systems that can capture very small particles are not able to sample and analyze the particles in real time, because such filtration systems generally use a type of mechanical media, sometimes in conjunction with electrostatic charges to aid in collecting the particles on the filter media. One major problem is that, even if the proper particles have been collected, they are deposited on the filter media which itself is not readily accessible by any type of sensor, since the filter's media is directly in the air flow pathway, and such sensors would themselves become quite dirty and therefore inefficient in short order.

### SUMMARY OF THE INVENTION

Accordingly, it is an advantage of the present invention to provide a dynamic electrostatic air particle collection and analysis apparatus that exhibits a substantially high air cleaning efficiency while also exhibiting a substantially low backpressure as air flows through the apparatus at useful rates for collecting particles in indoor spaces.

It is another advantage of the present invention to provide a dynamic electrostatic air collection and analyzing apparatus having a substantially high air cleaning efficiency with substantially low backpressure, and which does so over a substantial time period of continuous operation without either cleaning or replacing a major component of the apparatus.

It is a further advantage of the present invention to provide a dynamic electrostatic air collection and analyzing apparatus that can sample in real time for particular air particulates, or for specific biological organisms, and with the capability of generating an alarm warning when predetermined concentrations of specific particulates or organisms are detected.

It is yet a further advantage of the present invention to provide a dynamic electrostatic air collection and analyzing apparatus that uses charged liquid droplets to initially collect particulate matter or organisms from air passing through an indoor space, and then collect the liquid droplets that contain the particulate matter/organisms in a manner that “amplifies” the concentration of the materials of interest, and pass the collected liquid through a sensing apparatus that operates in real time.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a particle collection apparatus is provided, which comprises: a chamber into which a flow of input air is directed, the input air containing a plurality of particles; at least one nozzle through which a liquid is sprayed into the chamber, the liquid becoming separated into a plurality of electrically charged droplets upon exiting the at least one nozzle; a collecting surface; and the chamber being configured to cause the flow of input air and the charged liquid droplets to intermix within the chamber, wherein the plurality of particles are attracted to the plurality of charged liquid droplets which remove a portion of the plurality of particles from the input air, thereby forming a plurality of collected particles within the charged liquid droplets, the plurality of charged liquid droplets being collected at the collecting surface and thereby aggregating into a volume of liquid which contains the plurality of collected particles; and wherein the liquid is recirculated through the at least one nozzle and the chamber, and wherein the plurality of collected particles become increasingly concentrated within the liquid over time as the particle collection apparatus is operated.

In accordance with another aspect of the present invention, a particle collection apparatus is provided, which comprises: a chamber into which a flow of input air is directed, the input air containing a plurality of particles; at least one nozzle through which a liquid is sprayed into the chamber, the liquid becoming separated into a plurality of electrically charged droplets upon exiting the at least one nozzle; a collection surface; and the chamber being configured to cause the flow of input air and the charged liquid droplets to intermix within the chamber, wherein the plurality of particles are attracted to the plurality of charged liquid droplets which remove a portion of the plurality of particles from the input air, thereby forming a plurality of collected particles within the charged liquid droplets, the plurality of charged liquid droplets being collected at the collecting surface and thereby aggregating into a volume of liquid which contains the plurality of collected particles; and an analysis station to which the aggregated liquid is directed.

In accordance with yet another aspect of the present invention, a method for collecting particles entrained in air is provided, in which the method comprises the following steps: providing a chamber into which a flow of input air is directed, the input air containing a plurality of particles; providing at least one nozzle, spraying a liquid therethrough and into the chamber, the liquid becoming separated into a plurality of electrically charged droplets upon exiting the at least one nozzle; intermixing the input air and the charged liquid droplets within the chamber, wherein the plurality of particles are attracted to the plurality of charged liquid droplets, and thereby removing a portion of the plurality of particles from the input air to form a plurality of collected particles within the charged liquid droplets; collecting the plurality of charged liquid droplets at a collecting surface and aggregating them into a volume of liquid which contains the plurality of collected particles; and directing the liquid with the plurality of collected particles to an analysis station that detects at least one predetermined type of particle of the plurality of collected particles.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a diagrammatic view of a first embodiment depicting an air particulate/organism collection and analyzing system as constructed according to the principles of the present invention.

FIG. 2 is a graph showing the continuous slow build-up of a concentration of a predetermined material, and then a sudden increase in the specific material of interest that will generate an alarm, using the collection system of FIG. 1.

FIG. 3 is a graph showing the concentration of a predetermined material that is not expected to be found in a specific indoor space, and once it has been introduced in small levels, the collection system of FIG. 1 amplifies a concentration that can more quickly be detected.

FIG. 4 is a graph of collector liquid flow rate vs. collector droplet diameter using computer modeling data of a 10 inch×4 inch×2 inch air cleaner constructed according to the principles of the present invention.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

Other related electrostatic filtering or collecting devices are disclosed in commonly-assigned U.S. patent applications: Ser. No. 10/039,854, titled “Apparatus and Method for Purifying Air,” filed on Oct. 29, 2001, and Ser. No. 09/860,288, titled “System and Method For Purifying Air,” filed on May 18, 2001. These patent documents are incorporated herein by reference in their entirety.

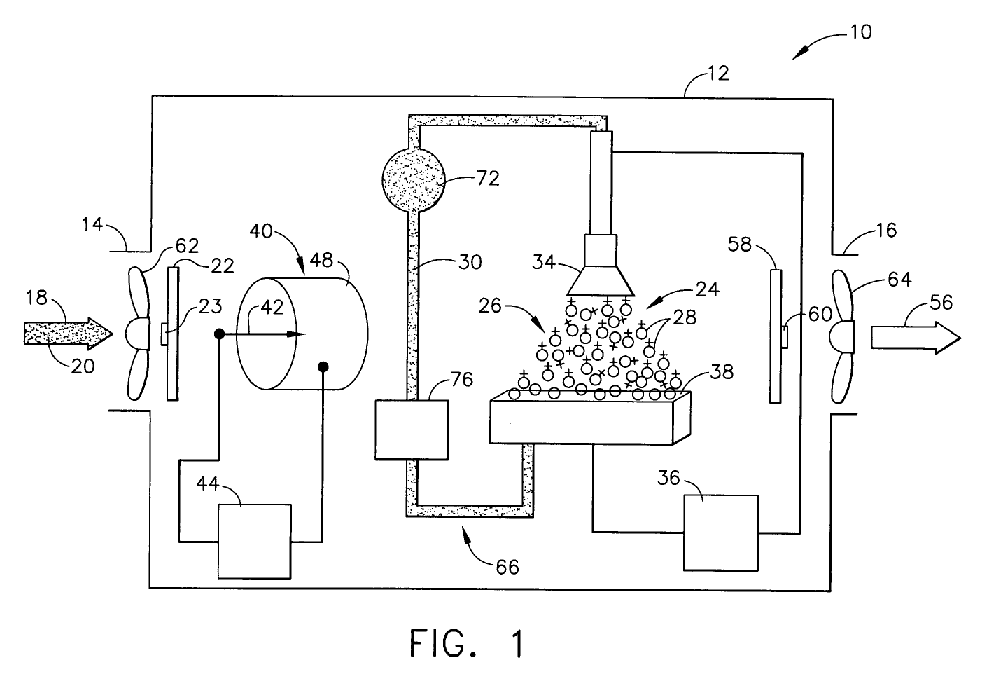

As seen in FIG. 1, an apparatus 10 for filtering air and/or collecting particulates in air includes a housing 12 having an inlet 14 and an outlet 16. It will be seen that inlet 14 is configured to receive an air flow designated generally by reference numeral 18. Air flow 18 is considered to be “dirty” air (identified by reference numeral 20) in the sense that it includes certain particles and/or biological matter. A mechanical (or media) pre-filter 22 may be included adjacent inlet 14 in order to prevent particles greater than the specified size from entering apparatus 10. A sensor 23 may also be located adjacent inlet 14 for monitoring the quality of air entering apparatus 10. For the present invention, the pre-filter is mainly used to remove relatively larger objects, such as human hair before the air flow reaches a filtering or collecting chamber.

Apparatus 10 includes a first chamber or defined volume 24 which is in flow communication with inlet 14, in which a charged spray 26 of semiconducting fluid droplets 28 having a first polarity (i.e., positive or negative) is introduced to the incoming air flow 18 while passing therethrough to outlet 16. Spray droplets 28 are preferably distributed in a substantially homogenous manner within first chamber 24 so that particles 20 become electrostatically attracted to and retained by spray droplets 28. With regard to terminology, “particles” 20 (or “particulate matter”.) represent both organic and inorganic matter, both living and non-living tissue, or cells, or spores, or germs, including bacteria and viruses, and dangerous inorganic matter including radioactive isotopes, and toxic or pathogenic materials. It will be seen that first chamber 24 includes a first device (e.g., a nozzle) for forming spray droplets 28 from a semiconducting fluid 30 supplied thereto and a second device (e.g., an electrostatically-charged member) for charging such spray droplets 28. It will be appreciated, however, that the charging device may perform its function prior to, subsequent, or during formation of spray droplets 28 by the first device.

Preferably, a spray nozzle 34 connected to an electrical power supply 36 (of approximately 18 kilovolts) is provided to serve the function of the first and second devices so that it receives the semiconducting fluid, produces spray droplets 28 therefrom, and charges such spray droplets 28. A collecting surface 38 spaced a predetermined distance from spray nozzle 34 is also provided in first chamber 24 to attract spray droplets 28, as well as particles 20 retained therewith. In this way, particles 20 are removed from air flow 18 circulating through apparatus 10. It will be appreciated that collecting surface 38 is either grounded, or it is electrically charged to a voltage that is of a second polarity opposite the first polarity of spray droplets 28 to enhance attraction thereto. In order for apparatus 10 to perform in an effective manner, the charge on spray droplets 28 is preferably maintained until striking collecting surface 38, whereupon such charge is neutralized.

Apparatus 10 may also include a second chamber or defined volume 40 which is in flow communication with inlet 14 at a first end of the second chamber, and is in flow communication with first chamber 24 at a second end. Second chamber 40 can charge particles 20 entrained in air flow 18 to a voltage that is of a second polarity opposite the first polarity of spray droplets 28, prior to air flow 18 entering first chamber 24. In order to provide such an electrical charge, an electric field in second chamber 40 would be created by at least one charge transfer element 42 (e.g., a charging needle) which is connected to an electrical power supply 44 (providing, for example, approximately 8.5 kilovolts). While charge transfer element 42 may be oriented in any number of directions, it is preferred that it be mounted within second chamber 40 so as to be substantially parallel to air flow 18.

Second chamber 40 further includes a ground element 48 associated therewith for defining and directing the electric field created therein. It will be appreciated that air flow 18 passes between charge transfer element 42 and ground element 48. A collecting surface may also be associated with second chamber 40, where such collecting surface could be electrically charged by charge transfer element 42 so as to be of opposite polarity to spray droplets 28 and thereby create an attraction. In order to better effect the charge on particles 20, a device may be provided in second chamber 40 for creating a turbulence in air flow 18 therein.

Turning back to first chamber 24, it will be understood that various configurations and designs may be utilized for spray nozzle 34 and collecting surface 38, but their shapes and differential distances should be matched so as to maintain a substantially uniform electric field in first chamber 24 in many engineering applications. Accordingly, when spray nozzle 34 is axisymmetric, collecting surface 38 could take the form of a ring washer, a funnel, a perforated disk, or a cylinder of wire mesh, for example. It will be understood that collecting surface 38 could be constructed of a solid plate, solid bar, or perhaps as a perforated plate in shape.

Another exemplary design for spray nozzle 34 is one where a multi-nozzle configuration is utilized. This may take the form of a Delrin body with a plurality of spray tubes that are in flow communication with such Delrin body and first chamber 24. It will be appreciated that any number of flow patterns may be provided by spray nozzle 34 when employing a multi-nozzle design. (See, for example, the patent documents noted above, that are incorporated by reference.)

It will be appreciated that spray droplets 28 may be produced in various ways from fluid 30. A high relative velocity may be preferred between fluid 30 and the surrounding air or gas so as to aid in atomizing fluid 30, and this can be accomplished by discharging fluid 30 at high velocity into a relatively slow moving stream of air or gas, or by exposing a relatively slow moving fluid to a high velocity air stream. Accordingly, those skilled in the art will understand that pressure atomizers, rotary atomizers, and ultrasonic atomizers may be utilized. Another device involves a vibrating capillary to produce uniform streams of drops. The present invention also contemplates the use of air-assist type atomizers, and when using such a spray nozzle, semiconducting fluid 30 is exposed to a stream of air flowing at high velocity. This may occur as part of an internal mixing configuration where the gas and fluid mix together within the nozzle before being discharged through the outlet orifice or an external mixing configuration where the gas and fluid mix at the outlet orifice.

Regardless of the precise configuration of spray nozzle 34 and collecting surface 38, it will be understood that spray droplets 28 are preferably distributed in a substantially homogeneous manner within first chamber 24. In many applications, it is better if the spray droplets 28 enter first chamber 24 at substantially the same velocity as air flow 18, especially if spray nozzle 34 is oriented in a different manner so that spray droplets 28 flow in a direction substantially the same as the direction of air flow 18. On the other hand, the spray droplets and air flow directions can be oriented substantially opposite to one another, or at an angle (e.g., substantially perpendicular) to one another, as illustrated in FIG. 1. The size of spray droplets 28 is an important parameter relative to the size of particles 20. Spray droplets 28 preferably have a size in a range of approximately 0.1-1000 microns, more preferably in a range of approximately 1.0-500 microns, and most preferably in a range of approximately 10-100 microns.

One design consideration should be the charge density that is imparted to the droplets: while a higher charging voltage at the nozzle 34 will likely further ensure that droplets will successfully be formed at the nozzle's exit, it normally is best to not use a voltage magnitude that will tend to cause the droplets to become very tiny (e.g., below 0.1 microns). Very tiny droplets may tend to be entrained in the air flow, and may thereby completely miss the “target” collecting surface 38. Of course, this would have two negative consequences: (1) such droplets would remove no particulates, and (2) the operating fluid would vanish over time. Furthermore, very tiny droplets may not be able to “grab” onto particles greater than a certain size, although very small particles would almost always be removed even by very tiny droplets.

Outlet 16 of housing 12 is in flow communication with first chamber 24 so that air flow directed therethrough (designated by arrow 56) is substantially free of particles 20. An optional oil filter 58 may also be provided adjacent outlet 16 in order to remove any spray droplets 28 which are not attracted by collecting surface 38 in first chamber 24. A sensor 60 may be provided at outlet 16 for monitoring the quality of air flow 56 upon exiting the apparatus 10. Moreover, in order to balance efficiency of apparatus 10 with the ability to substantially remove particles 20 from air flow 18, it will be appreciated that air flow 18 have a predetermined rate of flow through apparatus 10. To better maintain a desired flow rate, inlet 14 and/or outlet 16 also may include an air-moving device 62 and/or 64, such as a fan, to assist in drawing air flow 18 through inlet 14 through first and second chambers 24 and 32, or in pushing air flow 56 through outlet 16.

A control device typically is provided to operate apparatus 10 in a predetermined manner, including control of power supply 36, power supply 44, fan 62, and fan 64. Additionally, the control device would likely be connected to sensor 60 for monitoring the quality of air exiting apparatus 10 and to a sensor at a reservoir or sampling station 76 for monitoring the quality and flow rate of fluid 30 recirculated through a fluid recirculation system 66.

The fluid recirculation system 66 is preferably in flow communication with collecting surface 38 so as to capture fluid 30 that is aggregated from spray droplets 28, and to return this fluid to spray nozzle 34 in a continuous mode of operation. A pump mechanism 72 is provided to direct the fluid 30 to spray nozzle 34 under pressure.

The filtration and collection system depicted in FIG. 1 can be used as an electrostatic aerosol collection and fluorescence analysis system that will collect and categorize airborne particulate matter (e.g., particles, biological materials, organisms, etc.). The particulate matter that has been collected can be analyzed using a fluorescence analysis step to classify the particulate as being biological, if desired. An apparatus based on this system could be scaled from as small as a handheld unit to a much larger one capable of analyzing, for example, 1,000-2,000 cfm suitable for incorporation in an HVAC (heating ventilating air-conditioning) system of a building.

As discussed above, the filtering system electrohydrodynamically sprays a non-aqueous fluid into the incoming air stream. The fluid is broken into spray droplets which are charged during the spraying process, and which remove aerosols via electrostatic attraction and mechanical impact. These spray droplets are then collected (and typically grounded by the collection surface) and the collected liquid is either re-circulated or collected for later disposal. The spray fluid may contain fluorescent markers that will react with or bind to any biological particulate matter that has been collected, thereby allowing optical detection at very low concentrations. As the system removes the aerosol (i.e., the particulate matter, along with any fluorescent markers) and collects it in an inert liquid, it will preserve the aerosol material for later detailed forensic analysis.

The dynamic electrostatic filtration system can provide a very high efficiency of removal of small aerosol particles (sometimes greater than 99.99%) from an air stream with minimal backpressure characteristics. As an alternative to collecting the fluid that preserves the aerosol material, a decontamination system could be incorporated into the filtration/collection system to destroy any chemical or biological agents that have been collected. A photochemical system that utilizes reactive oxygen species such as superoxide could easily be incorporated into the liquid and activated by illumination, when needed. Again, this type of filtration system provides high efficiency aerosol removal with negligible backpressure characteristics.

The charged liquid droplets act as electrostatic collectors for the aerosol particles. If desired, the air entering the filtration/collection apparatus may be passed through a corona pre-charger (e.g., at the chamber 24) to increase the efficiency of removal for the airborne aerosols; however, this is not essential as the electric field around the fluid droplets will induce a dipole charge on the aerosol particles. On the other hand, pre-charging does reduce the size of the overall filtration/collection apparatus, and reduces the droplet density that otherwise is needed to attain efficient removal. As noted above, the non-aqueous liquid that essentially forms the filter is collected at a grounding plate, and thus the “filter” is constantly being renewed, as the electrostatic surface is kept “clean” so that removal efficiency is not lost during the lifetime of the collecting fluid.

An engineering model has been developed for the dynamic electrostatic filtration concept of the present invention. This model uses standard electrostatic filter methodology, and models a single electrostatic collector using a spherical droplet; these results are used to model a collection of droplets. This model initially uses a paper by Kraemer and Johnstone to calculate the single collector efficiency. This Kraemer and Johnstone paper is found in “Industrial and Engineering Chemistry” (1955) pages 47, 2426-2434. Kraemer and Johnstone used calculations and experiments to determine the collection efficiency of aerosol particles on small metal collecting spheres, and then calculated trajectories of particles moving toward a collector particle by solving first order differential equations for the equation of motion combined with electrostatic forces. At some critical initial starting position, referenced to a line that passes through the center of the collector, a limiting trajectory is defined. Particles that start between the critical initial position and the centerline are collected, and particles that start farther from the critical initial position are not collected. Kraemer and Johnstone calculated the limiting trajectories for different combinations of charged or uncharged collector or aerosol. From their theoretical and experimental work, Kraemer and Johnstone determined the following approximate expressions for single collector efficiency, η, for a charged collector and either a charged or uncharged aerosol.

EQUATION 1—Charged collector, charged aerosol:

η=−4K_{E}

$$EQUATION 2 \text{-} Charged collector , uncharged aerosol \text{:}$$

$$η = {( \frac{15 π}{8} {K}_{I} )}^{0.4}$$

In the above equations, K_{E} and K_{I} are dimensionless parameters whose magnitudes indicate the extent of electrostatic collection force relative to hydrodynamic forces that prevent electrostatic collection. These variables K_{E} and K_{I} have the following representation when the collector is at a constant charge:

$$EQUATION 3 \text{:}$$

$${K}_{E} = \frac{{Cq}_{p} {q}_{ac}}{3 π μ {d}_{p} {V}_{res} {ϵ}_{o}}$$

$$EQUATION 4 \text{:}$$

$${K}_{E} = C \frac{( ϵ - 1 )}{( ϵ + 2 )} \frac{2 {D}_{p}^{2} {q}_{ac}}{3 μ {d}_{c} {V}_{res} {ϵ}_{o}}$$

In electrostatic spraying, the droplets are assumed to have a specified charge, not a specified voltage. In Equations 3 and 4, “C” is the “Cunningham factor,” qₚ is the charge on the aerosol (e.g., dust), q_{ac} is the charge per unit area of the collection particles, ^{S}_{B} is the viscosity of air, Dₚ is the diameter of the dust, γₒ is the permittivity of free space, d_{c} is the diameter of the collection particle, and Vᵣₑₛ is the relative velocity between the electrostatically sprayed liquid and the aerosol (dust) particles. The constants ^{S}_{B} and γₒ are known from the literature, the value of γ was chosen to be typical of an insulator, the value of qₚ (the charge on the dust imparted by corona charging) was determined from standard textbook calculations. (See “Electrostatics: Principles, Problems, and Applications,” by J. L. Cross, published by Adam Hill in Bristol, England (1987), pages 46-60.) The value of q_{ac} was specified to be one-third of the value of the Rayleigh charge for the collector particle. Tang and Gomez have shown this assumption to be accurate for electrostatic spraying. (See “Journal of Aerosol Science,” by K. P. Tang and A. Gomez (1994), pages 25, 1237-1294.) The Cunningham factor was determined to essentially be equal to one (1) for the conditions of the present invention.

After determining the collection efficiency for one charged spray droplet, the collection efficiency for a cloud of charge droplets, η_{c}, may be estimated using the following equation:

$$EQUATION 5 \text{:}$$

$${η}_{c} = 1 - exp [ - \frac{3}{4} \frac{( 1 - φ )}{φ} η \frac{2 L}{{D}_{c} cos θ} ]$$

In Equation 5, L is the net distance from the air point-of-entry into the spray droplet cloud to the location where the air exits from the spray droplet cloud. The variable N is the void fraction in the collector droplet cloud. This equation was derived by Bertinat and Shapiro et al. for estimating the collector performance of solid, fibrous filters. However, it may be applied to the present invention if the reference frame is the collector droplet. (See “Journal of Electrostatics,” by M. P. Bertinat (1980), pages 9, 137-158, and “Aerosol Science and Technology,” by M. Shapiro and coworkers (1986), pages 5, 39-54.)

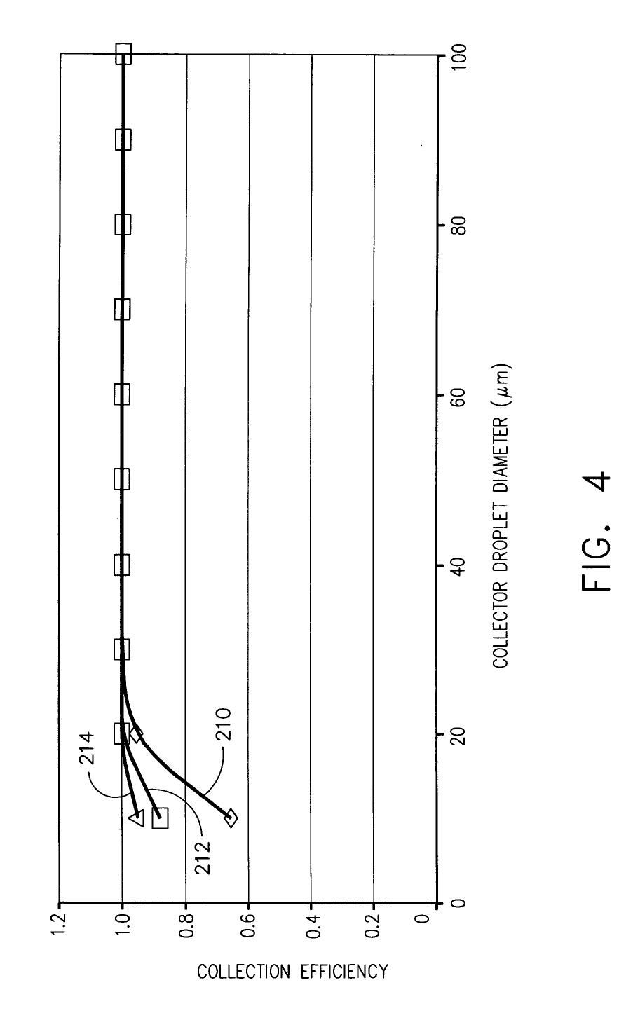

The engineering model described above can be used to describe a collector with dimensions 10 inches×4 inches×2 inches, and using an air flow rate of 110 cubic feet per minute (cfm). In this example, the air and electrostatic spray droplets co-flowed at a velocity of approximately 2 m/s (meters per second). The results indicate that a droplet density of 1,000-3,000 drops per cubic centimeter and a droplet size of 40 microns provide collection efficiencies of greater than 99%, as depicted in FIG. 4. A collecting unit of this size could provide room monitoring in which the room air turnover would be accomplished several times per hour.

The air filtration/collections apparatus of the present invention generates very little backpressure despite the very high collection efficiencies capable of being achieved. The 10×4×2 collector described above would generate only about 10⁻³ inches of water column backpressure, even at a flow rate of 500 cfm. As a result of this low backpressure, the apparatus would require very little power, thereby allowing the use of a battery electrical power supply as a practical proposition. Moreover, the low backpressure means that the apparatus will produce very little acoustic noise.

In addition to the example discussed above using computer modeling, a small-scale prototype apparatus has been constructed by the inventors. This prototype was about one-tenth in scale as compared to the modeled apparatus having 10×4×2-inch dimensions, and was tested using a flow rate of less than ten (10) cfm, and utilized a single spray head. This prototype achieved the following results, in which it collected greater than 99% of the aerosol particles that were present in the room air:

| Particle Size: | 0.25-1 microns |
|---|---|
| Inlet Particle Count: | 2.3 × 10⁶ |
| Outlet Particle Count: | ˜10⁴ |
| Removal Efficiency: | >99% |

The fluid used in the dynamic electrostatic filter/collecting apparatus of the present invention must be capable of being electrosprayed and maintaining its surface charge for the time it takes to traverse the distance between the spray head and the collection plate or surface. In general, the higher the fluid's electrical resistance, the longer it will maintain its surface charge in air. Conversely, the more resistive the fluid, the more difficult it is to be electrosprayed, as it cannot be so easily charged at the spray head. The formulation of the fluid should be balanced between the fluid's resistivity and charging characteristics, so that the spray can be charged to reasonable voltages, such as in the range of 8-20 kV, but that nevertheless will maintain its surface charge as droplets so that it can provide an efficient aerosol removal.

In addition to the electrohydrodynamic properties, the fluid should have a very low volatility so that it is not lost to the atmosphere by evaporation. Of course, this is more critical if the fluid is to be re-circulated in the collection system. In a situation where the spraying droplets are of a size around 50 microns, thereby providing a surface area of 0.5-1m²/cm³, it becomes obvious that unless the vapor pressure is very low, all of the fluid would be lost in a matter of days. It would be desirable for the fluid to have a lifetime in the range of 3-6 months for a re-circulating system. Fluids that are oligomeric or polymeric can be used to obtain this characteristic, and in the above-described prototype an exemplary fluid formulation based on polyethers was used and provided efficient aerosol collection. It has also been demonstrated that with use of an oligomeric fluid, the evaporation rates are sufficiently low to meet these objectives.

A major benefit of the dynamic electrostatic collection system of the present invention is that the aerosol particles collected by the fluid droplets (or e-mist) becomes suspended in the fluid, which facilitates their transport and analysis. Several types of analyses can readily be carried out on the aerosol once it has become suspended in the fluid. Examples of this are discussed below:

FLUORESCENCE ANALYSIS: The incorporation of fluorescent markers that will bind to or react with biological material such as protein, sugars, DNA, etc., will provide a basic means of identifying the biological material. The technology of fluorescent markers is well advanced and detection systems capable of marking different types of biological material are widely used at the present time. A major advantage of this type of analysis is that it can potentially provide an indication at very low concentrations of these biological materials.

There are several configurations that could be used with a fluorescence analysis in the present invention, depending upon the application. For example, the collection fluid could be re-circulated for a fixed period and then pumped into a separate analysis chamber where the fluorescent marker or markers are added and the analysis carried out. This becomes a batch-wise process that can be repeated with fresh fluid to provide appropriate (e.g., periodic) sampling of the room air. Of course, the “batch mode” of operation could command the “next” batch of samples based on several different criteria: it could be purely periodic (e.g., every eight hours) in an automatic operating mode, it could be implemented upon a manual command by an entry into a control panel, and it could be random or pseudo-random in a different automatic mode of operation.

As an alternative, the fluorescent marker could be incorporated into the fluid and the fluid re-circulated continuously. The fluorescence of the fluid itself then could be used to provide an alarm of the presence of the biological material of interest in the air stream. A relatively simple data processing routine could be used to warn of any sudden change in biological “load” that might indicate a threat. An example of how this would work is illustrated in FIG. 2, in which a graph showing a concentration of a particular biological material of interest is depicted as a line having a constant slope. This line is indicated at the reference numeral 100 between time zero (0) and a time T1. At this time T1, the sensing apparatus becomes effective, at a concentration level of C1. In other words, the sensor will not be able to detect negligible or minimal concentrations in most circumstances, and FIG. 2 demonstrates this along the line segment 100 at which time a biological substance could be slowly forming in the collecting fluid, but not yet able to be detected by a particular type of sensing apparatus until reaching the concentration level of C1. Of course, as sensors improve, the concentration level C1 could become very small indeed, particularly for a particular methodology of detection, such as detecting fluorescent light at a specific wavelength.

On FIG. 2, a continuation of the sloped line segment 100 is depicted at the reference numeral 102, which indicates that the biological material is constantly increasing, either due to a release into the room, or by growth of a self-replicating material, or by the fact that that collecting fluid acts as a “concentrator” by continually receiving more and more of the biological material even though its concentration in the room air remains relatively constant. (More on this feature below.) At the reference numeral 120, a sudden increase or “jump” in the concentration begins, and the data processing will notice this occurrence (in this theoretical example) at a concentration C2 that occurs at a time T2. Of course, using digital techniques for sensor inputs, the time between the reference numeral 120 and the time T2 could be very small indeed, and this illustrated example of FIG. 2 is exaggerated for the purpose of explanation.

On the other hand, if there was no sudden increase in the biological material of interest, then the sloped straight line would continue as indicated at the reference numeral 104, and no alarm would be generated by one of the collection alarm algorithms used in the present invention. However, if the sudden increase begins to occur at reference numeral 120, it would increase quite quickly to a new concentration level, as indicated along the line segment 110, after which it may tend to continue to increase at approximately its former rate, as indicated by the line segment 112. Of course, once the alarm has been given at time T2 based on the increase in concentration found at C2 over a very short time interval, then it really makes no difference where the actual concentration curve goes after that point. The room could be immediately evacuated and if necessary, quarantined.

The fluorescent marker could be chosen to be a “general” marker, i.e., it would react with all biological material of a given type. Alternatively, the fluorescent marker could be designed to have a degree of specificity for a “target” biological threat, and thus provide a specific warning. Several individual markers could be simultaneously used having different excitation/emission wavelengths to provide a broad threat coverage. Overall, fluorescence analysis can provide a very powerful tool for the identification of biological materials, especially when used in combination with the present invention as a collection system.

LIGHT SCATTERING/TURBIDITY ANALYSIS: The suspension of the aerosol particles in the collecting fluid means that light scattering and turbidity techniques can be used to provide information on aerosol load and size distribution. The technology for analysis of particles suspended in a fluid is already well established and a simplified functional sensing apparatus could be incorporated into the fluid path of the collecting fluid. Using light scattering, it would be possible to classify the size of the particles being collected. Simple data processing can be used to follow the particle sizes being collected and to provide a warning should there be a sudden increase in the collection of particles of a particular size, which may indicate a deliberate release.

While particle size analysis may be preferred when using some of the fluids of the present invention, a simple turbidity analysis could also be utilized. An increase in turbidity of the fluid over time can be monitored, and any sudden increase could be used as an alarm indicator. For both light scattering or turbidity analyses functions, the generalized example of FIG. 2 could be applicable when determining a “sudden” release of a biological material. This would also be true for any type of material, biological or otherwise. Certain radioactive isotopes could be detected using the light scattering or turbidity analyses functions, especially where the isotopes become part of molecules of fairly large sizes.

INFRARED ANALYSIS: Biological material can be characterized by certain functional groups, including the carbonyl group, and this grouping can be used to monitor for biologicals within the collecting fluid. Assuming that the collecting fluid itself does not contain carbonyl functionality, simple infrared analysis for carbonyls would provide a reasonably good indication of the presence of biological material.

POST-ANALYSIS: In addition to the above in-situ analyses methodologies, the collecting fluid could be diverted into a separate analysis chamber for a detailed post-analysis. Most of the fluids that can be best used in the dynamic electrostatic filter/collection system of the present invention are generally inert, and would not destroy the biological material. The fluid could therefore be removed from the collection apparatus, and the biological material could then be examined in a laboratory setting where a more detailed identification of the species could be carried out. There has been rapid development of a “lab-on-a-chip” technology that can perform some of the detailed analysis, for example a DNA analysis, and this may be realizable in the near future. The collecting fluid could easily be selectable to be compatible with techniques using the latest sensor technology, such as an antibody-based sensor. Another potential sensing technology could be ELISA, (enzyme linked immunoassay).

CONTINUOUS RE-CIRCULATION SYSTEMS: It should be noted that certain design considerations are important, and for example, any fluorescent markers that are added to the collecting fluid for a continuous mode system must be “compatible” with the collection apparatus itself, and also with the spray process. In other words, the fluorescent markers cannot have their properties substantially changed as a result of being electrically charged to a medium voltage (such as 20 kV).

In general the recommended fluids used in the dynamic electrostatic filter and collection system of the present invention will not destroy the biological material that has been collected. While this clearly is an advantage if a detailed analysis is desired, it could also present an issue if that detailed analysis is not required. It is the nature of this collection system (and all collection processes, for that matter) that the biological—and potentially pathogenic, or toxic—material that is collected becomes more concentrated, and could thus pose a threat to personnel handling the spent fluid of the system. An optional photochemical decontamination system could be added into the system so that, upon activation, exposure of the fluid to this photochemical decontamination system can provide a methodology for destroying the biological material that is present in the fluid. In general, this would involve exposing the fluid to a specific wavelength of light known to be deadly to the biological material that becomes present in the fluid, after being indicated by the collection system.

As an example, a photochemical generation of superoxide provides a greater than 10⁻⁷ reduction in gram-negative and gram-positive bacteria within thirty (30) minutes. Such a system could easily be incorporated in the filtration/collection system, since in effect, the filter/collection system is, in the main, a liquid.

It will be understood that the present invention can be constructed in the form of many small devices to handle a particular air space, which could be used to sample the air flow moving at relatively slow velocities. However, a single filtration/collection system constructed according to the present invention could also be used in which the air is moving at a much higher velocity. While the collection efficiency will ultimately begin to drop as air velocity increases, the filtration/collection system of the present invention can operate at much higher air velocities (while maintaining a very high collection efficiency) than conventional electrostatic systems or HEPA filters.

It should be noted that the “detection time” is a significant design criteria, and the air flow of a particular interior space should be modeled so as to determine the best locations for the filtration/collection systems of the present invention. The room air circulation pattern can determine proper placement of one or more aerosol collection devices. While modeling the air flow of a room is not part of the present invention per se, it would be an important design criteria to effectively ensure that the detection time is minimized for a given room or building.

With regard to detection time, it should be noted that certain types of biological or otherwise pathological materials should not be within a building or room under any circumstances. However, under the current conditions of potential terrorist activities, it is possible that undesirable (and perhaps deadly) biological or pathogenic materials could intentionally be injected into a room or building, as a terrorist act. In the case of biological materials, a very small amount of material could be injected or otherwise introduced into a building's air system, and certain organisms will begin to multiply once they are attached to human or other animal hosts. The present invention can also be used as a “concentrator” for early detection of predetermined biological hazards.

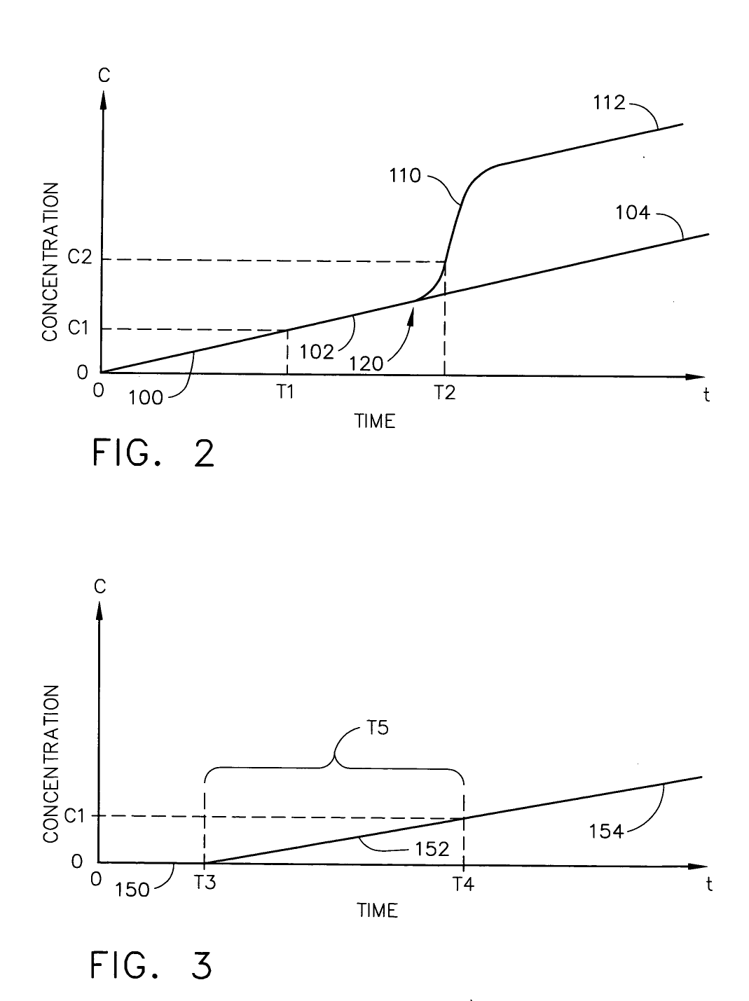

As an example, if a very small amount of smallpox is introduced into a building, once it travels through the air system and lands among human hosts, it will begin to multiply and its concentration will thus begin to increase in the air spaces themselves. An example of this situation is illustrated in FIG. 3. Referring now to FIG. 3, the horizontal line segment 150 represents the concentration of smallpox in normal circumstances (i.e., zero), however, at the time T3, the smallpox is introduced and begins to increase in concentration, as indicated by the line segment 152. Unfortunately, the concentration of the smallpox would still be undetectable using today's sensor technology, and a concentration that would become detectable would not occur until the time T4, which corresponds to a concentration C1 that represents the lowest detectable limit of a particular sensing system. In this situation, the time interval T5 indicates the amount of real time that occurs between the introduction of the smallpox and its possible detection using a specific type of sensor.

It is the present invention itself that helps to increase the slope of the line segment 152, because as the smallpox germs are collected, more and more of them will continuously be collected in the fluid 30, even if the actual room or building air does not exhibit a substantial increase in the concentration. The present invention thus effectively acts as a “concentrator” to make it possible for a smallpox sensor to detect the amplified concentration of the smallpox germs found in the collecting fluid of the present invention much faster than if the same type of sensor was merely sampling the actual building air. In other words, if the smallpox germs were barely increasing at all in the actual room air, there would still be an increase (as an amplifying effect) in concentration in the collecting fluid of the present invention.

Fortunately, many detectors are fairly sophisticated at this time such that the concentration limit C1 (of minimum possible detection) may be fairly small, and this would allow an alarm to be generated at the time T4 while a minimal number of persons have been exposed within the building or room space. Accordingly, action could be taken much more swiftly to seal off the building, and to begin treatment of the persons who have been exposed. This is a far better situation than to wait for some exposed person to begin exhibiting symptoms of the disease, which would not occur until the concentration found in the liquid of the present invention was much farther along the line 154 on FIG. 3.

The present invention will also act much more quickly than any type of program (e.g., in sensitive government or military buildings) that would be continuously growing cultures from air samples of the building. Such cultures may take days to become positive indicators of any type of problem, and moreover, a new culture would have to be started at predetermined time intervals, which will delay a positive indication in the event that a new culture sample has just been started just as the smallpox or other dangerous biological material is introduced. By use of the present invention, there will be a continuous collection and amplified concentration of any predetermined biological material, regardless as to when it actually is introduced into the building. Accordingly, the time interval T5 will always be a fairly well known fixed time interval, depending only upon the initial concentration of the smallpox (or other biological material) and other known variables, such as the number of exposed persons that may tend to become infected and to grow new germs within their own bodies that can be exhaled into the room air.

This “concentrator” aspect of the present invention is very important, and always will tend to amplify the concentration of predetermined biological (or other) materials. If more than one particular biological material is to be detected for a given building space, then it is quite easy to install multiple air filtration/collection systems, if desired, in a situation where only one specific type of germ or other biological material is to be detected per filter/concentrator for its particular collected fluid. Of course, a single air filter/collection system of the present invention could be used with multiple detectors, since the filtering is provided by the fluid itself, and the fluid can be directed to any number of sampling or detection stations before it is re-circulated back to the charging nozzles. Thus, there is almost an infinite number of design possibilities when using the present invention. The only limitation is the number of biologicals that are to be detected vs. the size of each individual collecting system or, if only one collecting system is used, then vs. the physical size of each detection station. Of course, the real limitation is the actual sensor technology itself, but this is always improving both in types of chemicals or biological materials that can be detected at all, and also in sensitivity.

It should also be remembered that the present invention can be used in a batch mode rather than in a continuous re-circulation mode, and the collecting fluid can be diverted for a very detailed analysis, virtually at any time during the operation of the device. All one would need to do would be to replace the collected fluid with new “clean” fluid as the batch is being taken from the system.

The type of detecting sensors is only limited by the imagination and capabilities of the designers of these sensors. As discussed above, the turbidity can be detected, which is an indication as to how much light passes through the collecting fluid as compared to the “normal”amount of such traversing light. Also a light-scattering detection scheme can be used, which would provide an indication of actual particle size, or particle size distribution. Also discussed above was the use of fluorescent markers, used with a form of spectraphotometric analysis. A spectraphotometric analysis can be used as either an absorption or emission arrangement, and can detect electromagnetic energy (e.g., light) at predetermined wavelengths. In addition to the above, radioactivity can be detected by use of a Geiger counter, for example. In this manner, dangerous radioactive isotopes can also be detected, relatively quickly in this instance.

In sum the present invention is capable of collecting virtually any type of physical matter known (or yet unknown) to man. The primary purpose of this collection can be either to destroy certain materials, or to analyze them. In either case, the main limitation is the type of sensor or type of destruction device that would be involved.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The invention claimed is:

1. A particle collection apparatus for removing particles from input air that is directed into said apparatus, comprising:
a chamber into which a flow of said input air can be directed;
at least one nozzle for spraying a liquid, said liquid becoming separated into a plurality of electrically charged droplets upon exiting said at least one nozzle, wherein said electrically charged droplets are directed into said chamber and said chamber is configured to cause said flow of input air and said electrically charged droplets to intermix; whereby said plurality of electrically charged liquid droplets remove at least a portion of said plurality of particles from said input air, thereby collecting a plurality of said particles from said input air;
a collecting surface for collecting said liquid sprayed from said nozzle subsequent to said liquid intermixing with said input air in said chamber; and
wherein said plurality of charged liquid droplets collected at said collecting surface are aggregated into a volume of liquid which contains said collected particles;
wherein said aggregated volume of liquid is re-circulated through said at least one nozzle and said chamber, whereby the concentration of particles collected from said input air can increase over time as said particle collection apparatus is operated.

2. The particle collection apparatus as recited in claim 1, wherein said particle concentration within said liquid actually increases over a time interval, even if a concentration of said particles in said input air does not increase over said time interval.

3. The particle collection apparatus as recited in claim 1, wherein said plurality of particles is a plurality of aerosol particles.

4. The particle collection apparatus as recited in claim 3, wherein said aerosol particles are comprised of particulate matter and fluorescent markers.

5. The particle collection apparatus as recited in claim 1, further comprising an analysis station that detects at least one predetermined type of particle of said plurality of collected particles.

6. The particle collection apparatus as recited in claim 3, wherein said analysis station operates in a continuous mode so as to detect a substantially sudden increase in a concentration of said at least one predetermined type of particle.

7. The particle collection apparatus as recited in claim 5, wherein said analysis station operates in a continuous mode so as to detect a gradual increase in a concentration of said at least one predetermined type of particle when said concentration reaches a level of substantially minimum detectability of said analysis station.

8. The particle collection apparatus as recited in claim 5, further comprising a collecting station; wherein said analysis station operates in a batch mode and, at appropriate intervals, directs said liquid containing said plurality of collected particles to said collecting station while simultaneously introducing unused liquid to said at least one nozzle to replace said liquid that has been directed to said collecting station.

9. The particle collection apparatus as recited in claim 8, wherein said collecting station performs a more detailed analysis on said at least one predetermined type of particle.

10. The particle collection apparatus as recited in claim 5, wherein said at least one predetermined type of particle comprises at least one of: (a) a biological organism; (b) a pathogenic compound; (c) a toxic compound; (d) a spore; and (e) a radioactive isotope.

11. The particle collection apparatus as recited in claim 5, wherein said analysis station comprises at least one of: (a) a light-scattering sensor; (b) a turbidity sensor; (c) a radioactivity sensor; (d) a spectraphotometric-type sensor detecting electromagnetic energy absorption; and (e) a spectraphotometric-type sensor detecting electromagnetic energy emission.

12. The particle collection apparatus as recited in claim 11, wherein said spectraphotometric-type sensor detects a fluorescent marker that is contained within said recirculated liquid, which fluorescent marker is attracted to a predetermined type of biological organism of said at least one predetermined type of particle.

13. A particle collection apparatus, comprising:
a chamber into which a flow of input air is directed, said input air containing a plurality of particles;
at least one nozzle through which a liquid is sprayed into said chamber, said liquid becoming separated into a plurality of electrically charged droplets upon exiting said at least one nozzle;
a collection surface; and
said chamber being configured to cause said flow of input air and said charged liquid droplets to intermix within said chamber, wherein said plurality of particles are attracted to said plurality of charged liquid droplets which remove a portion of said plurality of particles from said input air, thereby forming a plurality of collected particles within said charged liquid droplets, said plurality of charged liquid droplets being collected at said collecting surface and thereby aggregating into a volume of liquid which contains said plurality of collected particles; and
an analysis station to which said aggregated liquid is directed.

14. The particle collection apparatus as recited in claim 13, wherein said analysis station includes a sensor designed to detect at least one predetermined type of particle of said plurality of collected particles.

15. The particle collection apparatus as recited in claim 13, wherein said plurality of particles is a plurality of aerosol particles.

16. The particle collection apparatus as recited in claim 13, wherein said analysis station is located within a closed-loop of said liquid, and operates in a continuous mode so as to detect one of: (a) a substantially sudden increase in a concentration of said at least one predetermined type of particle, and (b) a gradual increase in a concentration of said at least one predetermined type of particle when said concentration reaches a level of substantially minimum detectability of said analysis station.

17. The particle collection apparatus as recited in claim 13, wherein said analysis station is located external to a path of said liquid and the apparatus operates in a batch mode such that, as desired, said liquid containing said plurality of collected particles is directed to said analysis station while simultaneously introducing unused liquid to said at least one nozzle to replace said liquid that has been directed to said analysis station.

18. The particle collection apparatus as recited in claim 14, wherein said at least one predetermined type of particle comprises at least one of: (a) a biological organism; (b) a pathogenic compound; (c) a toxic compound; (d) a spore; and (e) a radioactive isotope.

19. The particle collection apparatus as recited in claim 14, wherein said sensor comprises at least one of a type: (a) light-scattering; (b) turbidity; (c) radioactivity; (d) spectraphotometric absorption; and (e) spectraphotometric emission.

20. An aerosol particle collection apparatus, comprising:
a chamber into which a flow of input air is directed, said input air containing a plurality of aerosol particles;
at least one nozzle through which a liquid is sprayed into said chamber, said liquid becoming separated into a plurality of electrically charged droplets upon exiting said at least one nozzle;
a collecting surface; and
said chamber being configured to cause said flow of input air and said charged liquid droplets to intermix within said chamber, wherein said plurality of aerosol particles are attracted to said plurality of charged liquid droplets which remove a portion of said plurality of aerosol particles from said input air, thereby forming a plurality of collected aerosol particles within said charged liquid droplets, said plurality of charged liquid droplets being collected at said collecting surface and thereby aggregating into a volume of liquid which contains said plurality of collected aerosol particles;
wherein said liquid is re-circulated through said at least one nozzle and said chamber, and wherein said plurality of collected aerosol particles become increasingly concentrated within said liquid over time as said particle collection apparatus is operated.

21. The particle collection apparatus as recited in claim 20, wherein said aerosol particles are comprised of particulate matter and fluorescent markers.

22. The aerosol particle collection apparatus as recited in claim 20, wherein said aerosol particle concentration within said liquid actually increases over a time interval, even if a concentration of said aerosol particles in said input air does not increase over said time interval.

23. A method for collecting particles entrained in air, said method comprising:
providing a chamber into which a flow of input air is directed, said input air containing a plurality of particles;
providing at least one nozzle, spraying a liquid therethrough and into said chamber, said liquid becoming separated into a plurality of electrically charged droplets upon exiting said at least one nozzle;
intermixing said input air and said charged liquid droplets within said chamber, wherein said plurality of particles are attracted to said plurality of charged liquid droplets, and thereby removing a portion of said plurality of particles from said input air to form a plurality of collected particles within said charged liquid droplets;
collecting said plurality of charged liquid droplets at a collecting surface and aggregating them into a volume of liquid which contains said plurality of collected particles; and
directing said liquid with said plurality of collected particles to an analysis station that detects at least one predetermined type of particle of said plurality of collected particles.

24. The method as recited in claim 23, wherein said plurality of particles is a plurality of aerosol particles.

25. The method as recited in claim 23, wherein said liquid is directed through one of: (a) a closed-loop pathway, wherein said analysis station is located along said closed-loop pathway, and wherein a first particle concentration of said at least one predetermined type of particle within said liquid increases over time, even if a second concentration of said particles in said input air does not increase; and (b) an open-loop pathway to a batch collection station, wherein said analysis station is located at said batch collection station.

26. The method as recited in claim 23, wherein said at least one predetermined type of particle comprises at least one of: (a) a biological organism; (b) a pathogenic compound; (c) a toxic compound; (d) a spore; and (e) a radioactive isotope.

27. The method as recited in claim 23, wherein said analysis station comprises a one sensor of at least one of a type: (a) light-scattering; (b) turbidity; (c) radioactivity; (d) spectraphotometric absorption; and (e) spectraphotometric emission.
